(19) United States
(12) Patent Application Publication
(10) Pub. No.: US 2002/0154925 A1
(43) Pub. Date: Oct. 24, 2002

(54) Fuser in image forming apparatus

(75) Inventor: Hiroshi Oota, Tokyo (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/126,882

(22) Filed: Apr. 22, 2002

(30) Foreign Application Priority Data
Apr. 23, 2001 (JP) 2001-125140

(51) Int. Cl. G03G 15/20

(52) U.S. Cl. 399/327

(57) ABSTRACT

In order to provide a fuser which can prevent toner contaminants once adhered to a cleaning roller from being fused and again deposited on a heat roller or a press roller, two change-over cleaning rollers are provided for the heat or the press roller, and a temperature sensor is mounted to each cleaning roller. When one of the cleaning rollers, which is performing a cleaning operation, reaches a threshold temperature, it is moved into an inoperative position, but the other cleaning roller is brought into a cleaning position. The temperature sensor attached to the other cleaning roller monitors the temperature of the latter to cause the other cleaning roller to be brought out of the cleaning position. Thus, the cleaning rollers can be alternatively utilized.

### BACKGROUND OF THE INVENTION

1. Field of the Invention

This invention relates to a fuser in an image forming apparatus and more particularly, to a fuser of the type in which a sheet of printing paper, on which a toner image has been formed, is fed between a heat roller and a press roller to fix the toner image on the printing paper, while cleaning the peripheral surfaces of the heat and press rollers by pressing associated cleaning rollers against the heat and press rollers, respectively.

2. Description of the Prior Art

Referring to FIG. 7, there is shown a prior art fuser or fixing device having a structure that includes a heat roller 1, a press roller 2, cleaning rollers 3 and 4 for the heat and press rollers 1 and 2, respectively, and a peeling-off claw 5 serving for the heat roller 1. In this fuser, a sheet of printing paper with a toner image formed thereon is fed into the nip between the heat and press rollers 1 and 2 from a certain upstream station in order to fix or fuse the toner image on the paper sheet under pressure and with heat. Then, the paper sheet with the fused toner image is sent out downstream from between the heat and press rollers 1 and 2. Even if the paper sheet to be sent out is adhered to the peripheral surface of the heat roller 1, the peeling-off claw 5 can peel off the adhered sheet from the heat roller 1, so that no trouble will occur. It is also noted that the cleaning rollers 3 and 4 can remove any toner stains or contaminants possibly present on the heat and press rollers 1 and 2, respectively.

With the conventional fuser as mentioned above, if the temperatures of the cleaning rollers 3 and 4 are within a normal range, the toner contaminants removed from the heat and press rollers 1 and 2 can be remained stuck on the cleaning rollers 3 and 4, but do not adhere again to the heat and press rollers 1 and 2. However, when the temperatures of the cleaning rollers 3 and 4 are increased beyond a preset level due to, for example, continuous printing operation during which a number of paper sheets consecutively pass through the nip between the heat and press rollers 1 and 2, toner contaminants adhered to the cleaning rollers 3 and 4 would become dissolved and transferred to the heat and press rollers 1 and 2 and hence to each printing paper passing therebetween, causing contamination of an image thereon. Thus, the cleaning rollers 3 and 4 can not achieve their object to prevent contamination of the heat and press rollers 1 and 2.

### SUMMARY OF THE INVENTION

The present invention has been provided to overcome the above difficulties. Accordingly, it is an object of the present invention to provide a fuser for use in an image forming apparatus, in which cleaning rollers, capable of operatively contacting with a heat roller or a press roller, are designed so that their temperatures do not exceed a preset value in order to prevent toner contaminants once adhered to the cleaning rollers from being dissolved and re-adhered to the heat or press roller.

In order to overcome the aforementioned disadvantages, according to one aspect of the present invention, a fuser in an image forming apparatus is provided, which comprises: a heat roller for heating a toner image formed on the surface of a sheet of paper to fix the toner image thereto; a press roller for pressing the sheet of paper against said heat roller; at least two cleaning rollers for cleaning the surface of said heat roller or said press roller, said cleaning rollers being selectively positioned in contact with the surface of said heat roller or said press roller under pressure; changeover means for alternatively bringing one of said at least two cleaners into an operative position in which said one cleaning roller is pressed against said heat roller or said press roller and the other of said at least two cleaners into an inoperative position in which said other cleaning roller is separated from said heat roller or said press roller; means for detecting a temperature of a cleaning roller, which is brought into the operative position by said changeover means; and means operatively connected to said temperature detecting means for controlling and driving said changeover means based on said detected temperature so that an operative cleaning roller is changed over from the cleaning roller in the operative position to the cleaning roller in the inoperative roller.

In this fuser, preferably, said temperature detecting means is separately provided for each cleaning roller.

Furthermore, said control means advantageously controls and drives said changeover means so that an operative cleaning roller is changed over from the cleaning roller in the operative position to the cleaning roller in the inoperative roller when said cleaning roller in the operative position reaches a temperature of predetermined level or more.

According to another aspect of the present invention, there is provided a fuser of the type wherein a sheet of print paper with an toner image formed thereon is passed between a heat roller and a press roller to the toner image to the sheet of print paper, and wherein cleaning rollers are provided for the heat roller and the press roller and pressed against the heat and press rollers, respectively, to clean the surfaces of the associated heat and press rollers, said fuser being characterized by: at least two change-over cleaning rollers provided for one of the heat and press rollers; a temperature sensor associated with each of said at least two change-over cleaning rollers to detect a temperature thereof; and control means operatively connected to said temperature sensors for controlling operations of said at least two change-over cleaning rollers so as to cause one of at least two change-over cleaning rollers to perform a cleaning operation until a temperature sensor associated with said one of at least two change-over cleaning rollers detects a threshold temperature and thereafter, on one hand, to cause said one of at least two change-over cleaning rollers to cease the cleaning operation and, on the other hand, to cause the other of at least two change-over cleaning rollers to perform a cleaning operation.

According further aspect of the present invention, there is provided a fuser of the type wherein a cleaning roller is pressed against a heat roller or a press roller to perform a cleaning operation thereon, said fuser being characterized in that two change-over cleaning rollers are provided to be alternatively bring into use so that when a temperature of a cleaning roller in use increases over a predetermined level, a cleaning roller out of use is brought in use in lieu of the cleaning roller in use.

With the arrangement being such that, the control means can always bring one of two change-over cleaning rollers, which has a low temperature below a threshold level, into a cleaning operation, so that toner contaminants once adhered to the change-over cleaning rollers do not again deposited on the heat roller or the press roller.

### BRIEF DESCRIPTION OF THE DRAWINGS

The preferred embodiments of the present invention will now be described by way of example only with reference to the accompanying drawings, in which:

FIG. 1 is a diagrammatic view illustrating essential parts of a fuser according to the first embodiment of the present invention;

FIG. 2 is a diagrammatic view illustrating essential parts of a fuser according to the second embodiment of the present invention;

FIG. 3 is a table providing results of a performance test for the fuser incorporating the first and second embodiments of FIGS. 1 and 2 thereinto, in comparison with test results with respect to a conventional fuser;

FIG. 4 is a graphical illustration of a change in image contamination when the temperature of the cleaning roller(s) is changed, with toners having different effusion temperatures being employed;

FIG. 5 shows a graph of change in temperature of each of cleaning rollers which are alternatively brought into operative positions;

FIG. 6 shows a graph obtained by combining portions of the curves shown in FIG. 5, during which they are in contact with the press roller 2, i.e., in the operative position; and

FIG. 7 is a diagrammatic view illustrating a conventional fuser.

### PREFERRED EMBODIMENTS OF THE INVENTION

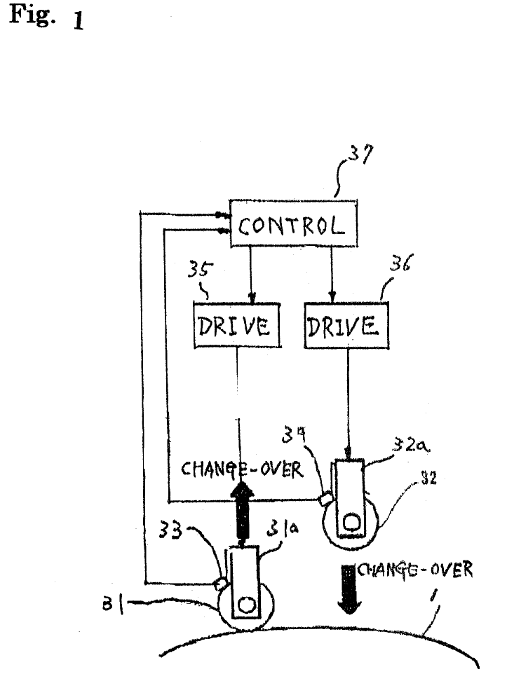

Referring now to FIG. 1, a fuser or fixing device according to the first embodiment of the present invention is shown partially, in which a pair of cleaning rollers 31 and 32 are employed for cleaning a heat roller 1, in place of the single cleaning roller 3 provided in the conventional fuser of FIG. 7 for cleaning the heat roller 1.

The cleaning rollers 31 and 32 are mounted to associated movable support structures 31a and 32a, respectively, which also support known temperature sensors 33 and 34 so that they can be placed in contact with the associated circumferential surfaces of the cleaning rollers 31 and 32, respectively, to detect their temperatures. The fuser further includes drive mechanisms 35 and 36 operatively associated with the respective roller support structures 31a and 32a for alternatively bringing the cleaning rollers 31 and 32 into contact with heat roller 1, and a controller 37 operatively associated with both the temperature sensors 33 and 34, as well as the drive mechanisms 35 and 36. As will be apparent from the following, the controller 37 can control the operations thereof in response to the outputs of the temperature sensors 33 and 34 representative of the surface temperatures of the heat roller 1.

Although not shown in the drawings, each of the drive mechanisms 35 and 36 may be of any construction, as far as it can selectively move an associated cleaning roller into and out of operative position, in which the associated cleaning roller is in contact with the peripheral surface of the heat roller 1. For example, each roller support structure may be solenoid actuated. Alternatively, both the support structures 31a and 32a with the cleaning rollers 31 and 32 may be mounted to a common turret support rotatable about an axis extending in parallel to that of the heat roller 1. The support structures 31a and 32a are attached to the turret support so that when the latter rotates some angle about its axis, either the cleaning roller 31 or 32 becomes in contact with the heat roller 1.

Alternatively, each cleaning roller with journals at the opposite ends thereof may be directly attached to the turret supports at the journals thereof. In this case, the support structures 31a and 32a can be removed.

When the fixing device is brought into image fixing operation, the controller 37 commands the drive mechanism 35 to bring one (in this example, roller 31) of the cleaning rollers 31 and 32 into a cleaning, operative position in which it contacts the heat roller 1 under pressure to perform a cleaning operation therefor. At this time, the cleaning roller 31 is at a temperature below a predetermined threshold level. Simultaneously with the commencement of the cleaning operation, the temperature sensor 33 begins to monitor the temperature of the cleaning roller 31 and outputs a signal representative of the monitored temperature to the controller 37. The cleaning roller 32 is maintained in an inoperative position away from the heat roller 1 as shown in FIG. 1.

When the controller 37 receives the output signal from the temperature sensor 33 indicating that the monitored temperature of the heat roller 1 has reached the predetermined threshold level, it commands the drive mechanism 36 to bring the cleaning roller 32 into a cleaning, operative position in which it contacts the heat roller 1 under pressure to perform a cleaning operation therefor. Simultaneously, the temperature sensor 34 begins to monitor the temperature of the cleaning roller 32 and outputs a signal representative of the monitored temperature to the controller 37. The controller 37 also commands the drive 35 to move the cleaning roller 31 from the operative position into the inoperative position. Subsequently, the above-described changeovers of the cleaning roller 31 from the operative position into the inoperative position and of the cleaning roller 32 from the inoperative position into the operative position are repeated, so that the cleaning operation can be always performed by one of the cleaning rollers 31 and 32, which has a temperature below a threshold level.

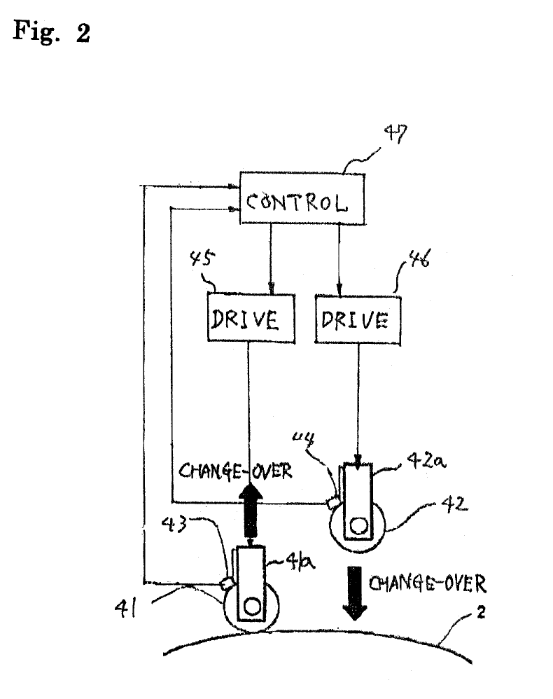

Referring to FIG. 2, a fuser or fixing device according to the second embodiment of the present invention is shown partially, in which a pair of cleaning rollers 41 and 42 are employed for cleaning a press roller 2, in place of the single cleaning roller 4 provided in the conventional fuser of FIG. 7 for cleaning the press roller 2.

The cleaning rollers 41 and 42 are mounted to associated movable support structures 41a and 42a, respectively, which also support known temperature sensors 43 and 44 so that they can be placed in contact with the associated circumferential surfaces of the cleaning rollers 41 and 42, respectively, to detect their temperatures. The fuser further includes drive mechanisms 45 and 46 operatively associated with the respective roller support structures 41a and 42a for alternatively bringing the cleaning rollers 41 and 42 into contact with the press roller 2, and a controller 47 operatively associated with both the temperature sensors 43 and 44, as well as the drive mechanisms 45 and 46. As will be apparent from the following, the controller 47 can control the operations of the drive mechanisms 45 and 46 in response to the outputs of the temperature sensors 43 and 44 representative of the surface temperatures of the press roller 2.

Although not shown in the drawings, each of the drive mechanisms 45 and 46 may be of the same construction as that of the drive mechanisms 35 and 36.

In operation, the controller 47 commands the drive mechanism 45 to bring one (in this example, roller 41) of the cleaning rollers 41 and 42 into a cleaning, operative position in which it contacts the press roller 2 under pressure to perform a cleaning operation therefor. At this time, the cleaning roller 41 is at a temperature below a predetermined threshold level. Simultaneously with the commencement of the cleaning operation, the temperature sensor 43 begins to monitor the temperature of the cleaning roller 41 and outputs a signal representative of the monitored temperature to the controller 47. The cleaning roller 42 is maintained in an inoperative position away from the press roller 2 as shown in FIG. 2.

When the controller 47 receives the output signal from the temperature sensor 43 indicating that the monitored temperature of the press roller 2 has reached the predetermined threshold level, it commands the drive mechanism 46 to bring the cleaning roller 42 into a cleaning, operative position in which it contacts the press roller 2 under pressure to perform a cleaning operation therefor. Simultaneously, the temperature sensor 44 begins to monitor the temperature of the cleaning roller 42 and outputs a signal representative of the monitored temperature to the controller 47. The controller 47 also commands the drive 45 to move the cleaning roller 41 from the operative position into the inoperative position. Subsequently, the above-described changeovers of the cleaning roller 41 from the operative position into the inoperative position and of the cleaning roller 42 from the inoperative position into the operative position are repeated, so that the cleaning operation can be always performed by one of the cleaning rollers 41 and 42, which has a temperature below a threshold level.

It is preferred that both the embodiments shown in FIGS. 1 and 2 are incorporated into the same fixing device. However, either of the embodiments, which have more teeth, may be incorporated into the fixing device.

The test results concerning the embodiment of FIG. 2 will be described below in comparison with those of the conventional fixing device.

The conditions, under which the tests were conducted on both the inventive fixing device and the conventional fixing device, are as follows: The heat roller 1 comprised a cylindrical aluminum material having an outer diameter of 60 mm (inverse crown of 180 μm) and a wall thickness of 8 mm, the outer surface thereof being coated with a fluorocarbon resin of 25 μm in thickness. The press roller 2 had inner and outer diameters of 55 mm and 60 mm and was made of rubber with a hardness of 45° (JIS-A), onto which a fluorocarbon tube having a diameter of 90 μm was fitted. The total load on the press roller 2 was set to 900 N (Newton) and the temperature of the heat roller 1 was controlled to be maintained at 200° C. During the fixing operation, the heat and press rollers 1 and 2 was rotated at the peripheral speed of 400 to 450 mm/sec while being retained in contact with each other.

Furthermore, each of the cleaning rollers 31 and 32 for the heat roller 1 was of 28 mm in diameter and associated with a 24-mm-dia silicon oil tank (containing 70 grams silicon oil having a viscosity of 30 thousands CS), and each cleaning roller for the heat roller was covered with a 10 grams silicon oil-impregnated heat-resistant felt of 2 mm in thickness. Each of the cleaning rollers 41 and 42 for the press roller 2 was a 28-mm-dia aluminum roller. A4-size printing papers each having 64 to 80 grams in weight were used. The number of successively carried out printings in one lot was about 1,000 prints for a document having a factor of 60% printed area. The styrene-acrylic toner having a glass transition temperature of about 56 to 62° C. and an effluent temperature of 120° C. was used.

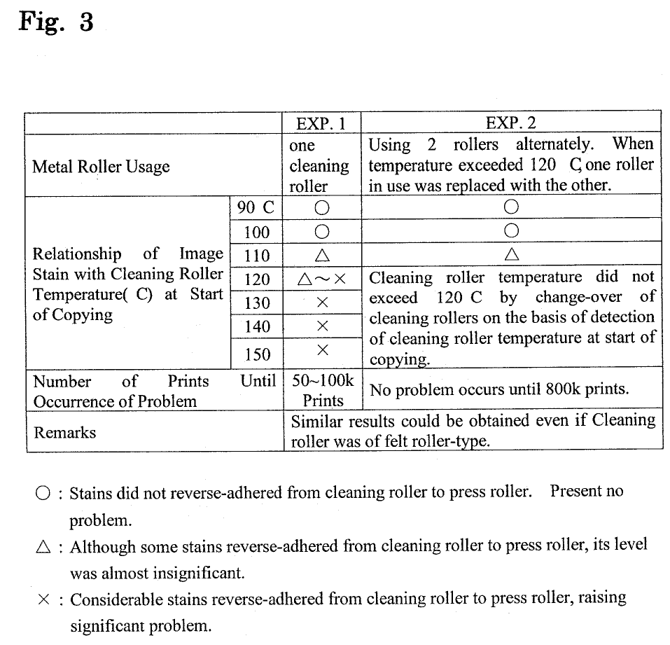

FIG. 3 shows the test results obtained by conducting the experiments under the above conditions. In Experiment 1 shown in FIG. 3, a single cleaning roller (metal roller) 4 was in service. Although no problem was presented when the cleaning roller 4 was held at a temperature of 120° C. or less, image stains occurred when the temperature exceeded 120° C., because toner contaminants, which are adhered to the cleaning roller 4, became fused and again attached to the press roller 4, resulting in transfer thereof to a sheet of printing paper. Also, it was found that even when the temperature of the cleaning roller 4 increased, the image stains did not occur unless the toner contaminants were built up to some extent, but occurred after the prints of 50 to 100 k (k=1,000).

In Experiment 2, two cleaning rollers 41 and 42 alternatively brought into their operative position were used to allow the cleaning operation to be always performed at a temperature below a threshold level (120° C.). Thus, the reverse adherence of the toner stain to the cleaning roller 4 did not occur, and no problem raised until the prints of 800 k have been completed. This means that with respect to an image stain, the useful service life of each cleaning roller can be increased by a factor of about 4 to 8.

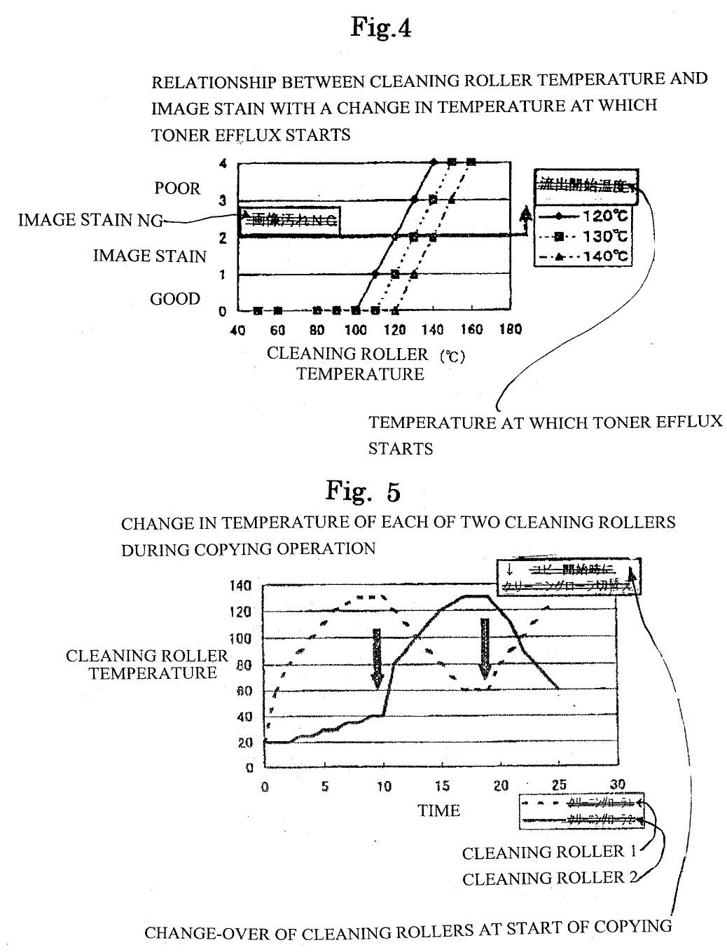

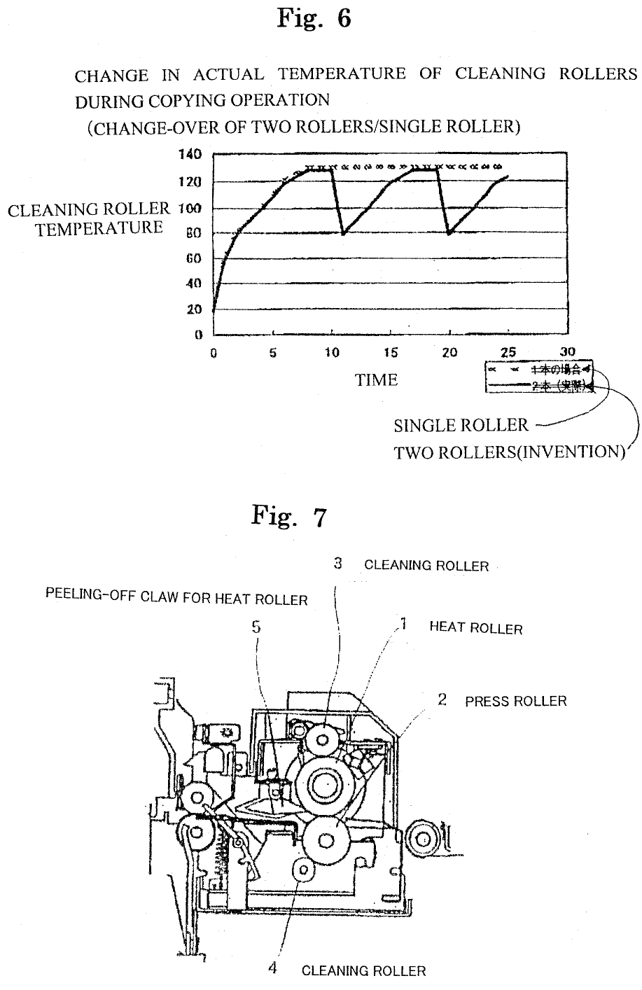

Regarding the fixing device used in Experiment 2, the following could be found. FIG. 4 shows a toner stain-and-cleaning roller temperature relationship with toners having different effluent commencement temperatures being used. The change in temperature of each of the cleaning rollers 41 and 42, alternatively changed over from the operative position to the inoperative position and vise versa, can be shown as in FIG. 5. FIG. 6 shows the change in temperature of the cleaning roller 41 or 42, which is in contact with the press roller 2, i.e., in the operative position.

From the foregoing, it can be understood that as the fixing device according to the present invention comprises two change-over cleaning rollers for each of heat and press rollers or either of the heat or press roller, and a temperature sensor mounted to each cleaning roller to detect a temperature thereof so that when one of the cleaning rollers, which is performing a cleaning operation, reaches a threshold temperature, the other cleaning roller is brought into a cleaning operation, the cleaning can be always performed by the cleaning roller, of which temperature is maintained below a threshold level. Therefore, the toner contaminants once adhered to the cleaning roller do not fuse with heat, so that no contaminants are again deposited on the heat roller and/or the press roller, with the result that a good image fixing can be effected.

What is claimed is:

1. A fuser in an image forming apparatus comprising:
a heat roller for heating a toner image formed on the surface of a sheet of paper to fix the toner image thereto;
a press roller for pressing the sheet of paper against said heat roller;
at least two cleaning rollers for cleaning the surface of said heat roller or said press roller, said cleaning rollers being selectively positioned in contact with the surface of said heat roller or said press roller under pressure;
change-over means for alternatively bringing one of said at least two cleaners into an operative position in which said one cleaning roller is pressed against said heat roller or said press roller and the other of said at least two cleaners into an inoperative position in which said other cleaning roller is separated from said heat roller or said press roller;
means for detecting a temperature of a cleaning roller, which is brought into the operative position by said changeover means; and
means operatively connected to said temperature detecting means for controlling and driving said change-over means based on said detected temperature so that an operative cleaning roller is changed over from the cleaning roller in the operative position to the cleaning roller in the inoperative roller.

2. A fuser as set forth in claim 1, wherein said temperature detecting means is separately provided for each cleaning roller.

3. A fuser as set forth in claim 1, wherein said control means controls and drives said change-over means so that an operative cleaning roller is changed over from the cleaning roller in the operative position to the cleaning roller in the inoperative roller when said cleaning roller in the operative position reaches a temperature of predetermined level or more.

4. A fuser of the type wherein a sheet of print paper with an toner image formed thereon is passed between a heat roller and a press roller to the toner image to the sheet of print paper, and wherein cleaning rollers are provided for the heat roller and the press roller and pressed against the heat and press rollers, respectively, to clean the surfaces of the associated heat and press rollers, said fuser being characterized by:
at least two change-over cleaning rollers provided for one of the heat and press rollers;
a temperature sensor associated with each of said at least two change-over cleaning rollers to detect a temperature thereof; and
control means operatively connected to said temperature sensors for controlling operations of said at least two change-over cleaning rollers so as to cause one of at least two change-over cleaning rollers to perform a cleaning operation until a temperature sensor associated with said one of at least two change-over cleaning rollers detects a threshold temperature and thereafter, on one hand, to cause said one of at least two change-over cleaning rollers to cease the cleaning operation and, on the other hand, to cause the other of at least two change-over cleaning rollers to perform a cleaning operation.

5. A fuser of the type wherein a cleaning roller is pressed against a heat roller or a press roller to perform a cleaning operation thereon, said fuser being characterized in that:
two change-over cleaning rollers are provided to be alternatively brought into use so that when a temperature of a cleaning roller in use increases over a predetermined level, a cleaning roller out of use is brought in use in lieu of the cleaning roller in use.
